(19) United States
(12) Patent Application Publication
(10) Pub. No.: US 2007/0033058 A1
(43) Pub. Date: Feb. 8, 2007

(54) A METHOD OF MARKETING AND MANUFACTURING A BED ASSEMBLY

(76) Inventor: Sheldon GRABER, Clive, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/161,488

(22) Filed: Aug. 5, 2005

(51) Int. Cl. G06Q 99/00

(52) U.S. Cl. 705/1

(57) ABSTRACT

A method of marketing and manufacturing a bed assembly where a box spring, a mattress having a removable top, and a plurality of comfort layers are selected from a variety of options based on a customer's desired level of comfort. Once selected a customer evaluates the selected assembly as compared to the desired level of comfort. Once acceptable, a bed assembly is manufactured based on the selection that meets the customer's desired comfort level.

### BACKGROUND OF THE INVENTION

This invention is directed toward a method of marketing and manufacturing a bed assembly, and more specifically to a method that allows a customer to select a bed assembly based on the customer's individual comfort level.

Shopping for a bed can be a time consuming and tiring process. Because most mattresses are pre-assembled, a customer sometimes must visit several retail establishments before finding an acceptable bed assembly. Occasionally, after visiting a few stores, a customer will settle for a bed assembly that does not meet the customer's desired level of comfort in order to bring the search to an end. Therefore, a need exists for a better way to market and manufacture a bed assembly.

An objective of the present invention is to provide a method of marketing a bed assembly that better satisfies a customer's needs.

Another objective of the present invention is to provide a method of marketing a bed assembly that allows a customer to easily evaluate how a selected bed assembly compares to a desired comfort level.

A still further objective is to provide a method of marketing and manufacturing a bed assembly that allows a customer to select from a variety of options.

These and other objectives will be apparent to one skilled in the art based on the following disclosure.

### SUMMARY OF THE INVENTION

A method of marketing and manufacturing a bed assembly where a box spring, a mattress having a removable top, and a plurality of comfort layers are selected from a variety of options based on a customer's desired level of comfort. Once selected a customer evaluates the selected assembly as compared to the desired level of comfort. Once acceptable, a bed assembly is manufactured based on the selection that meets the customer's desired comfort level.

### BRIEF DESCRIPTION OF THE DRAWINGS

FIG. 1 is a perspective view of a bed assembly;

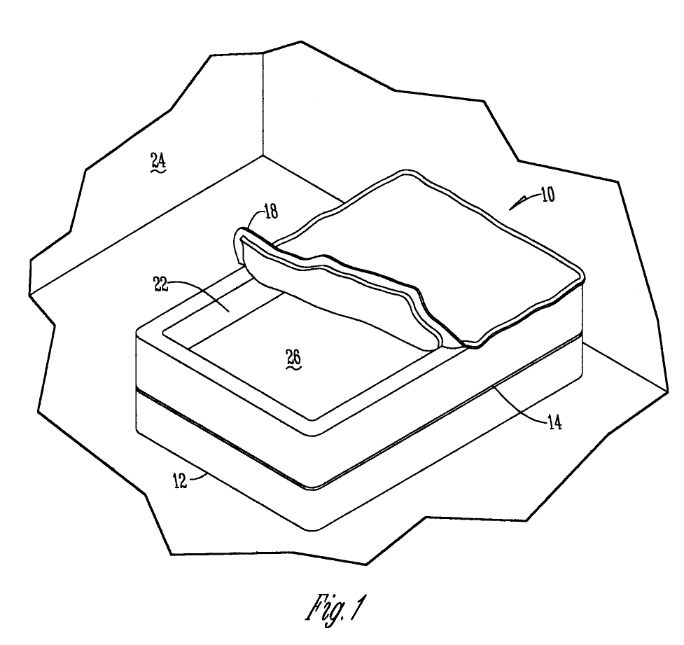

FIG. 2 is a side view of a bed assembly; and

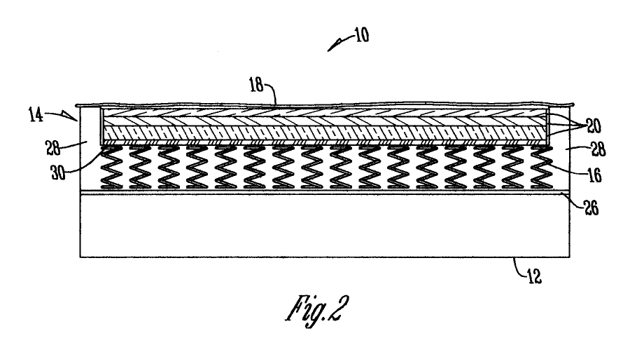

FIG. 3 is a flow diagram of a method of marketing and manufacturing a bed assembly.

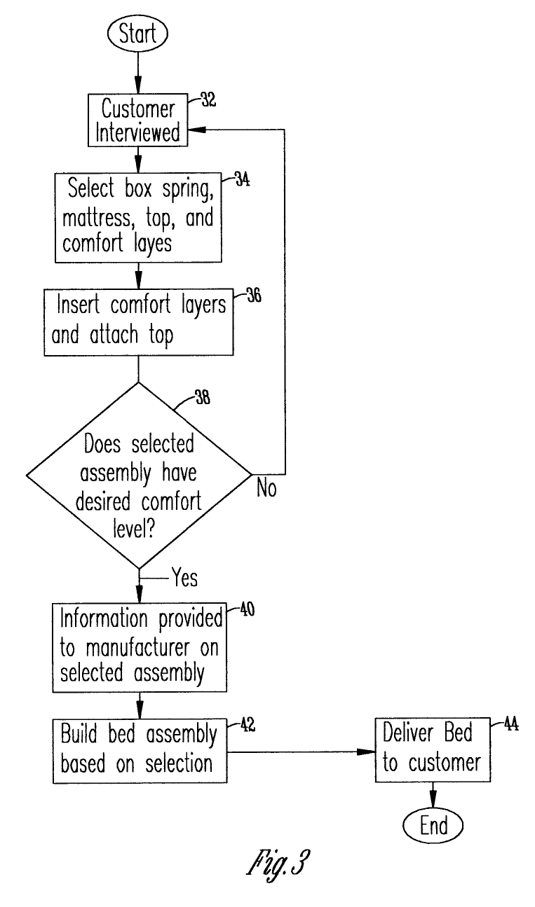

### DETAILED DESCRIPTION OF THE PREFERRED EMBODIMENT

Referring to the Figures, a method of marketing and manufacturing a bed assembly 10 is described in the context of a conventional retail establishment, however the invention is not limited in this manner and may be practiced in other venues and environments. A bed assembly includes a box spring 12, a mattress 14 having an inner spring configuration 16 and removable top 18, and a plurality of comfort layers 20 that are inserted within a chamber 22 of the mattress.

Within a retail establishment 24, a plurality of box springs 12 having one or more configurations are provided. For example, the box springs 12 may have coils, while others may be constructed of a solid material providing a solid foundation. Placed upon the box springs 12 is one mattress 14 selected from a plurality of mattresses having one or more different inner spring configurations 16 such as pocket coils, springs or the like. The mattress 14 has a bottom panel 26, side panels 28 and a insulator pad 30 that contain the spring configuration 16 in a lower portion of the mattress 14. The chamber 22 is formed by the divider panel 30 and a portion of the side panels 28 in an upper portion of the mattress.

Removably attached to the side panels 28 of the mattress 14 is a top 18. The top is removably attached in any conventional manner such as a zipper, Velcro®, snaps, or the like, to provide access to chamber 22. A plurality of different tops 18 having different thickness are available for attachment to the mattress.

Also, available for insertion within the chamber 22 are a plurality of comfort layers 20. The comfort layers 22 are of different types such as foam, latex, felt pads, or the like and are arranged in any order and/or combination as desired.

While any number of combinations of box springs 12, mattresses 14, and tops 18 are possible, preferred within a retail establishment 24 are a minimum of three different box springs 12, six different mattresses 14, and six tops 18.

The process begins at step 32 where a customer is interviewed to assess the customer's individual desired comfort level. Based on the customer's desired comfort level a box spring 12, mattress 14, top 18, and a plurality of comfort layers 20 are selected and the layers 20 inserted into chamber 22 at step 34.

The removable top 18 is attached to the mattress 14 to close the chamber at step 36. Once closed, the customer evaluates the level of comfort provided by the bed assembly 10 and determines if the desired level of comfort has been met at step 38. If the desired level of comfort has not been met, then steps 34, 36, and 38 are repeated. If the desired level of comfort is met then information on the selected box spring 12, mattress 14, top 18, and comfort layers is provided to the manufacturer at step 40. The manufacturer is either located on site or at a remote location.

The manufacturer takes the information on the selected bed assembly 10 and builds the assembly based on the customer's selections at step 42. In this step, the manufacturer adheres the comfort layers 20 to the mattress 14 such as by gluing, sewing, or innertufting the layers together and to the mattress 14. Also, the top is sewn on so that in the finished bed assembly 10, the top 18 is not removable. Once assembled, the bed assembly 10 is delivered to the customer at step 44.

From this disclosure a method of marketing and manufacturing a bed assembly has been shown that meets the stated objectives. The description of the invention is merely exemplary in nature, and, thus, variations that do not depart from the gist of the invention are intended to be within the scope of the invention. Such variations are not to be regarded as a departure from the spirit and scope of the invention.

What is claimed is:

1. A method of marketing and manufacturing a bed assembly; comprising the steps of:
providing at least one box spring, at least one mattress having at least one removable top, and a plurality of comfort layers;
determining a desired comfort level;
selecting a combination of comfort layers based on the desired comfort level to create a selected comfort level; and
evaluating the selected comfort level as compared to the desired comfort level.

2. The method of claim 1 further comprising the step of selecting one box spring, one mattress, and one removable top.

3. The method of claim 1 further comprising the step of interviewing a customer to determine the desired comfort level.

4. The method of claim 1 further comprising the step of manufacturing the bed assembly based on the comfort level.

5. The method of claim 4 wherein the step of manufacturing includes adhering the comfort layers together and to the mattress.

6. The method of claim 4 wherein the step of manufacturing includes providing a top that is not removable.
